(19) United States
(12) Patent Application Publication
(10) Pub. No.: US 2008/0156252 A1
(43) Pub. Date: Jul. 3, 2008

(54) Method and apparatus for continuously and selectively raising up a flag or a banner

(76) Inventor: Anas Ahmad AL-Tawarh, Abu Dhabi (AE)

Correspondence Address: Anas AL-Tawarh;UAE Area Management, P.O. Box 875, Abu Dhabi, omitted

(21) Appl. No.: 11/645,395

(22) Filed: Dec. 27, 2006

(51) Int. Cl. G09F 17/00

(52) U.S. Cl. 116/174

(57) ABSTRACT

Method and apparatus for continuously and selectively raising up a flag or a banner. Generally, flags, banners, some signs and the like are erect only in the presence of natural wind. In the absence of natural wind, they are normally not erect and not clearly visible. The present method and apparatus keep flags, banners and the like fluttering and raised up with or without the existence of natural wind. The absence of natural wind is detected and then an air pump is activated to keep the flag or banner raised up. Wind sensors, timers or even light sensors are used for selectively turning the air pump on to keep the flag or banner fluttering. Manual override such as manually or remotely disconnecting the power source is also provided.

### FILED OF THE INVENTION

Generally, flags, banners, some signs and the like are erect only in the presence of natural wind. In the absence of natural wind, they are normally not erect and not clearly visible. As a matter of fact, one may not be able to ascertain what type of banner or which flag it is when natural wind is not present. This invention is intended to solve this problem. The present invention is unique and novel method and apparatus for keeping flags, banners and the like fluttering and raised up with or without the existence of natural wind.

### BRIEF DESCRIPTION OF THE DRAWINGS

FIG. 1 represents an exemplary embodiment of the present invention showing the basic components.

FIG. 2 represents an exemplary air spreader.

FIG. 3 represents an exemplary automatic electrical key or switching mechanism.

FIG. 4 represents an anti skewing part.

### BRIEF DESCRIPTION OF THE INVENTION

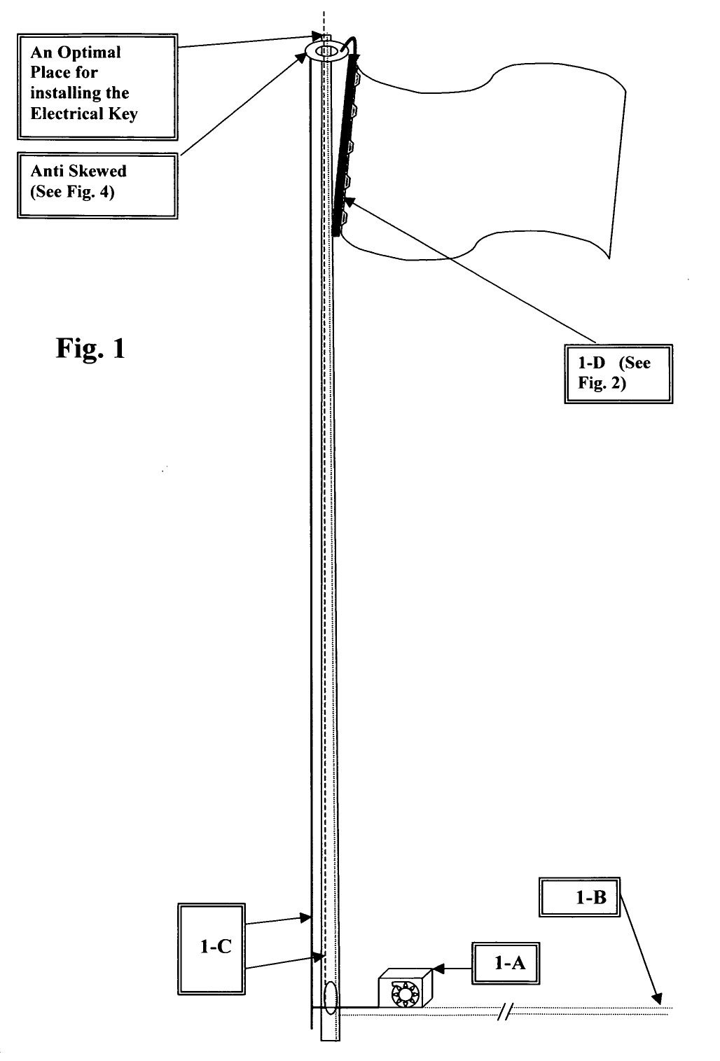

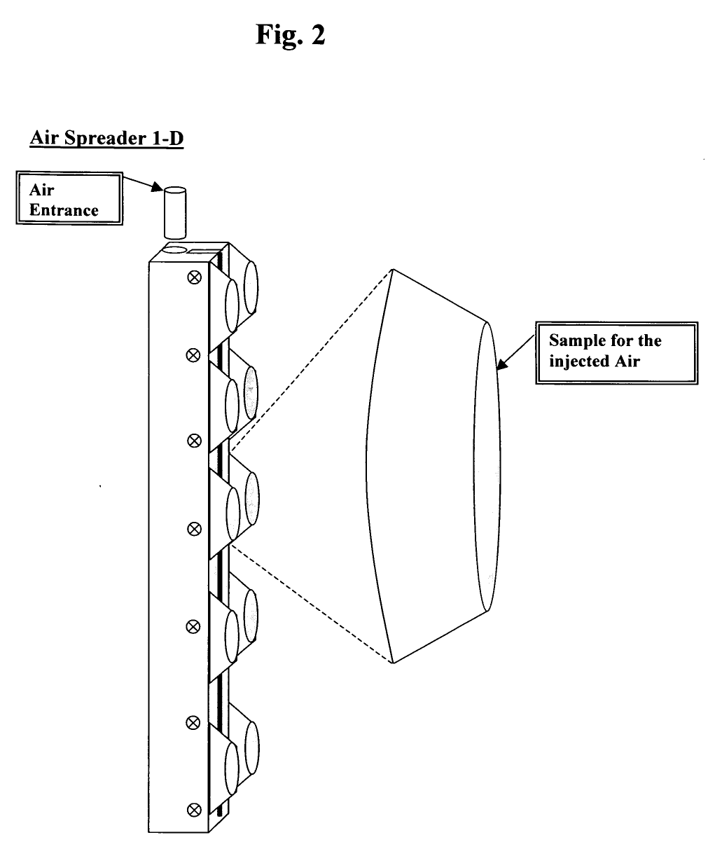

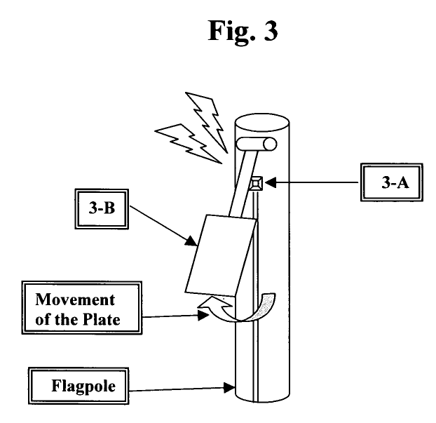

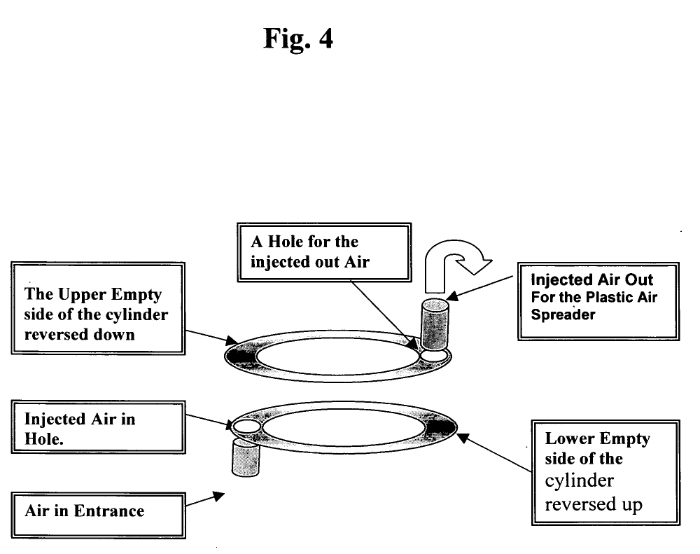

An exemplary embodiment of the invention utilizes the following parts:
Air pump with a suitable strength (capacity) to raise or keep erect the flag or the banner. See 1A (FIG. 1)
A suitable power supply to operate the air pump. This, for example, may be, but not limited to, one or more of AC, DC current from a battery or batteries or power provided by solar cells. The power is for example provided via 1B (FIG. 1)
An empty tube, preferably with a transparent color, or a color nearly matching the flagpole's color, not heavy weight, and should preferably resist heat, and other weather conditions like cold, humidity and wind. See 1C (FIG. 1)
A suitable strong air spreader that may preferably be plastic and should resist heat, and other weather conditions like cold, humidity and wind. See ID (FIG. 1) in general view and see FIG. 2 for details.
An automatic electrical key or suitable switching mechanism such as the exemplary one shown in FIG. 3, which works according to the speed of the wind as follows:
   completes the electrical circuit and starts the air pump to push the air to the flag in case of no natural wind to keep the flag, the banner or the like fluttering.
   disconnects the electrical circuit and stops the air pump in the presence of natural wind that raises the flag.
   this key or switching mechanism is chosen to work in a specific wind speed and is preferably installed at the top of the flagpole (the most effective place for measuring the wind speed).
An anti skewing part (FIG. 4) is preferably installed at the top of the flagpole in order to prevent the flag from skewing around the flagpole.
   The single air tube (FIGS. 1/1-C) in the above exemplary embodiment may be used with or replaced by trebled air tubes, to use in case of a national occasion or a holiday in order to mix the air with any desired color(s) (e.g., mist) such as the colors of the country's flag or a company's special color(s) to bring out a nice view for a special event or for advertising purposes. Again, the above is an exemplary embodiment and one skilled in the art may, for example, use more than one air pump or more than one tube without departure of the spirit of the present invention. Multiplicity or duplication of components is hereby expressly contemplated.

### DETAILED DESCRIPTION OF THE INVENTION

The main goal of the invention is to keep a flag, a banner or the like fluttering and erect at all times, or at least during desired periods of times (e.g., during daytime) and under adverse weather conditions without relying solely on natural wind. This invention will work during sunny, rainy, and/or humid days or under other adverse weather conditions.

The automatic electrical key or switching mechanism (3A, FIG. 3) contains a small light plate (3B), and an on/off electrical switch (3A). The on/off electrical switch may be any suitable type as described below. Air affects this plate as follows:
A) When there is sufficient wind, this will raise up the plate, and the electrical switch will not be affected by the weight of the plate (i.e., the switch is OFF—not pressed—) so the Flag is rising up by natural wind.
B) When the natural wind is insufficient to raise the plate, the weight of the plate will press it down against the electrical switch, and thus pressing it ON. This will complete the electrical circuit and will thus start the air pump which pushes the air to the top of the flagpole through the transparent tube. The anti skewing part (FIG. 4) receives the air. The air goes through the anti skewing part and then goes out to the air spreader (FIG. 2). The air will be injected through the spreader along both sides of the flag, but not on one side. This will prevent the flag from skewing around the flagpole. The air will play the role of natural wind and raise up the flag or the banner. The process will keep the flag or the banner raised at all times.
   Since the direction of the wind may not be exactly vertical and may be horizontal, the plate shown in FIG. 3 may be replaced with or used in combination with other plate(s) so that wind blowing horizontally will also raise or move the plate from the switch to keep it in the OFF position.
   Any type of available and known wind sensor(s) may be utilized to turn on and off the switch to actuate the air pump. The sensor may turn on and off the air pump electrically (i.e., send an an/off signal) or manually by pressing and un-pressing switch 3A. The wind sensor may also be in a shape of a fan with blades that rotate when wind is blown in any possible direction. Fan's motion may be used to generate a small electric current, which in turn would be detected to turn off the air pump. That is, detection of the small current indicates presence of wind and causes the air pump to be turned off, and vice versa. One skilled in the art of electrical engineering would easily and readily implement this.
   The above-mentioned electrical key is any suitable switch that is pressed for ON and un-pressed for OFF and may for example have a spring. This external spring key is weatherproof and may, for example, be protected by a rubber cover or the like to protect it from adverse weather conditions such as rain.

### Air Spreader (FIG. 2):

The Flag will be fixed inside the plastic air spreader along between the holes that injects the air out, so that the air will be injected on both sides of the flag. The spreader is preferably, but not necessarily, plastic. Any other suitable material may be used.

### Anti Skewing Part (FIG. 4):

Anti skewing cylinder is divided from the middle into two parts; one part has a hole for the air to enter (“air in”), and the other part has a hole for the air to exit (“air out”). The upper empty side of the cylinder is reversed down, and the lower empty side of the cylinder is reversed up. Both sides gathered to each other to bring out a complete circled cylinder. The gathered cylinder is free of movement from the middle (between both sides). That is, the upper side can move in a circular movement, when the direction of the air changes and the lower side stays fixed. This will prevent the flag or the banner from skewing around itself.

The invention has practical and moral characteristics. The practical goal is to maintain a flag or a banner fluttering and raised up at all or desired times under adverse weather conditions without relying on natural wind. The invention will keep the flag visible with all of its parts and colors, and also colors may be injected in the air for improving the view. The moral side is that the symbol of the country or the company will stay raised up as a proud symbol and may also be used as an improved advertisement means for keeping a company banner erect at all times.

While the above is merely an exemplary embodiment, many other obvious modifications may be made without departing from the spirit of the invention. For example, the air pump or pumps may also be switched on and off manually as desired, by a remote control, or by using a timer, for example, for day and night operation. Also, the use of other types of wind or light sensors to operate the switch is contemplated by the present invention. That is, the use of other wind sensors is positively contemplated by this invention. A light sensor may also be used to, for example, turn the pump on during daylight and turn it off after dark. Any and all reasonable combinations of the above features are hereby positively and expressly contemplated by this invention. For example, if the wind speed is varying greatly on a given day, the on/off switch may be turned on manually or remotely to remain on until manually or remotely turned off. It is preferable to select the color of the air spreader to be the same as or close to the color of the flag or banner. Furthermore, it is preferred to install the tube or tubes inside the flagpole so that it will not be visible which will give a better view, and to protect the installations from the weather conditions, and to increase its assumed life. The present invention is represented by the following claims.

I claim:

1. A method for maintaining a flag or a banner erect in the presence or absence of natural wind comprising:
detecting the absence of natural wind, and
in response to detecting the absence of natural wind, activating air blowing for supplying air to said flag or banner for erecting said flag or banner.

2. The method of claim 1 further comprising:
detecting the presence of natural wind, and
in response to detecting the presence of natural wind, deactivating said air blowing.

3. The method of claims 1 further comprising:
blowing air at both sides of said flag or banner to keep said flag or banner erect and to prevent skewing.

4. The method of claims 1 further comprising:
injecting colors into the blown air.

5. The method of claims 2 further comprising:
activating air blowing in response to a manual override, light sensor or a timer.

6. An apparatus for maintaining a flag or a banner erect in the presence or absence of natural wind comprising:
means for detecting the absence of natural wind, and
means for activating air blowing means for supplying air to said flag or banner for erecting said flag or banner in response to detecting the absence of natural wind.

7. The Apparatus of claim 6 further comprising:
means for detecting the presence of wind, and
means for deactivating said air blowing in response to detecting the presence of wind.

8. The apparatus of claim 6 further comprising:
means for blowing air at both sides of said flag or banner to keep said flag or banner erect and to prevent skewing.

9. The apparatus of claims 6 further comprising:
means for injecting colors into the blown air.

10. The apparatus of claims 7 further comprising:
means for activating air blowing in response to a manual override, light sensor or a timer.
